(19) United States
(12) Patent Application Publication
(10) Pub. No.: US 2023/0326330 A1
(43) Pub. Date: Oct. 12, 2023

(54) COMMUNICATION SYSTEM IN WHICH REMOTE CONTROL IS PERFORMED FROM TERMINAL APPARATUS, SERVER APPARATUS, CONTROL METHOD THEREFOR, AND STORAGE MEDIUM

(71) Applicant: CANON KABUSHIKI KAISHA, Tokyo (JP)

(72) Inventor: SHINSAKU KOBAYASHI, Chiba (JP)

(21) Appl. No.: 18/295,468

(22) Filed: Apr. 4, 2023

(30) Foreign Application Priority Data
Apr. 7, 2022 (JP) 2022-064067

(51) Int. Cl. G08C 17/00

(52) U.S. Cl. CPC G08C 17/00

(57) ABSTRACT

A communication system includes a terminal apparatus, a server apparatus, and a plurality of electronic devices which receives operation commands from the terminal apparatus, by which even if the number of electronic devices remotely controlled by the terminal apparatus increases, burden of operation and checking on a user can be reduced. In the communication system, server apparatus receives a simultaneous operation command for the plurality of electronic devices from the terminal apparatus, based on the simultaneous operation command, sends operation commands to the respective ones of the electronic devices related to the simultaneous operation command, receives notifications of statuses after the execution of the operation commands from the respective ones of the electronic devices related to the simultaneous operation command, and sends one notification about the statuses of the electronic devices related to the simultaneous operation command to the terminal apparatus.

### BACKGROUND OF THE INVENTION

### Field of the Invention

The present invention relates to a communication system in which a remote control is performed from a terminal apparatus, a server apparatus, a control method therefor, and a storage medium.

### Description of the Related Art

A communication system that uses a terminal apparatus such as a smartphone to monitor the statuses of electronic devices connected to a network and operate the electronic devices is commonly known. According to Japanese Laid-Open Patent Publication (Kokai) No. 2014-217072, based on an operation performed on the terminal apparatus by a user, the terminal apparatus sends operation commands to the electronic devices via the network. The electronic devices that have received the operation commands perform processing based on the operation commands and notify the terminal apparatus of their statuses after executing the operation commands via the network. The terminal apparatus receives the statuses of the electronic devices after the execution of the operation commands and notifies the user of them. Thus, the user is able to operate the electronic devices with the terminal apparatus and then check the statuses of the respective electronic devices after the operation or the like.

However, in a case where the user operates each of the electronic devices from the terminal apparatus and the terminal apparatus receives status notifications from the respective electronic devices and displays them, as described in Japanese Laid-Open Patent Publication (Kokai) No. 2014-217072, it takes a lot of time and effort for the user to perform operation and checking. Particularly, if there are many electronic devices to be operated with the terminal apparatus, and the user operates the electronic devices collectively (at a time) one by one in order, the user needs to check notifications, which are displayed for the respective electronic devices in random order, one by one. In order to check whether or not all of the electronic devices operated at once are in desired statuses, the user needs to check individual notifications for the respective electronic devices one by one. Moreover, every time the user performs an operation, he or she needs to determine whether or not he or she has already checked notifications about all of the electronic devices which he or she operated.

Thus, for the communication system including the terminal apparatus and the electronic devices receiving commands from the terminal apparatus, there is a demand to reduce the burden of operation and checking on the user of the terminal apparatus even if the number of electronic devices to be remotely controlled from the terminal apparatus increases.

### SUMMARY OF THE INVENTION

Accordingly, the present invention provides a communication system comprising a terminal apparatus, a server apparatus, and a plurality of electronic devices configured to receive operation commands from the terminal apparatus via the server apparatus, wherein the server apparatus comprises one or more controllers configured to function as a first unit configured to receive a simultaneous operation command for the plurality of electronic devices from the terminal apparatus, a second unit configured to, based on the simultaneous operation command, send operation commands to respective electronic devices related to the simultaneous operation command, a third unit configured to receive notifications of statuses after the execution of the operation commands from the respective electronic devices related to the simultaneous operation command, and a fourth unit configured to send, to the terminal apparatus, one notification about the statuses of the respective electronic devices related to the simultaneous operation command.

According to the present invention, even if the number of electronic devices remotely controlled by the terminal apparatus increases, the burden of operation and checking on a user of the terminal apparatus can be reduced.

Further features of the present invention will become apparent from the following description of exemplary embodiments with reference to the attached drawings.

### BRIEF DESCRIPTION OF THE DRAWINGS

FIG. 1 is a view useful in explaining a basic configuration of an example of a communication system according to a first embodiment of the present invention.

FIG. 2 is a view useful in explaining a basic configuration of various electronic devices in FIG. 1.

FIG. 3 is a view useful in explaining a basic configuration of a terminal apparatus in FIG. 1.

FIG. 4 is a view useful in explaining a basic configuration of a server apparatus in FIG. 1.

FIG. 5 is a view showing an example of a list of electronic devices capable of being remotely controlled through the server apparatus in FIG. 4.

FIG. 6 is a view showing an example of a list of terminal apparatuses capable of remotely controlling electronic devices through the server apparatus in FIG. 4.

FIG. 7 is a view useful in explaining an example of transition of screens to be displayed on the terminal apparatus in FIG. 3 when simultaneous operations are registered in the server apparatus in FIG. 4.

FIG. 8 is a view showing an example of a sequence that is executed when simultaneous operations are registered by the terminal apparatus and the server apparatus.

FIG. 9 is a view useful in explaining an example of transition of screens displayed when simultaneous operations are performed in the terminal apparatus in FIG. 3.

FIG. 10 is a view showing an example of a sequence of simultaneous operations in the communication system, which is executed by an operation on the terminal apparatus in FIG. 9 in a case where the result combining setting is OFF.

FIG. 11 is a view showing an example of a sequence of simultaneous operations in the communication system, which is executed by an operation on the terminal apparatus in FIG. 9 in a case where the result combining setting is ON.

FIG. 12 is flowchart showing how the server apparatus in FIG. 4 controls the execution of simultaneous operations.

FIG. 13 is flowchart showing how the server apparatus in FIG. 4 controls the notifications of simultaneous operations.

FIG. 14 is a view useful in explaining a variation of a screen displayed on the terminal apparatus when simultaneous operations are registered in the server apparatus in a communication system according to a second embodiment of the present invention.

FIG. 15 is a view useful in explaining an example of a confirmation screen for the results of simultaneous operations, which is displayed on the terminal apparatus in accordance with the execution of the simultaneous operations in the case where the simultaneous operations in FIG. 14 have been registered.

FIG. 16 is a flowchart showing how the server apparatus controls the notifications of simultaneous operations, which is capable of displaying the confirmation screen in FIG. 15 on the terminal apparatus.

### DESCRIPTION OF THE EMBODIMENTS

The present invention will now be described in detail below with reference to the accompanying drawings showing embodiments thereof. It is to be understood, however, that the embodiments described below are only illustrative, and the scope of the present invention is not intended to be limited by configurations in the embodiments described below.

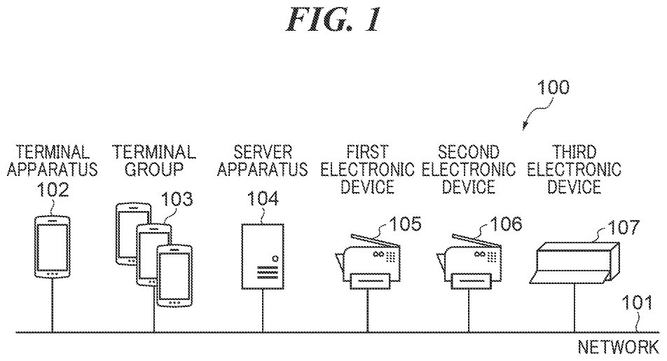

FIG. 1 is a view useful in explaining a basic configuration of an example of a communication system 100 according to a first embodiment of the present invention. The communication system 100 in FIG. 1 has a terminal apparatus 102, a terminal group 103, a server apparatus 104, a first electronic device 105, a second electronic device 106, a third electronic device 107, and a network 101 to which they are connected. The network 101 may be configured as a single intra network or may have a configuration in which a plurality of networks including the Internet are connected to one another by routers. The terminal apparatus 102 and the terminal group 103 mentioned above can be, for example, mobile terminals, smartphones, and tablet terminals, which are capable of wireless communication. In this case, the network 101 should include a wireless communication router capable of wirelessly communicating with the terminal apparatus 102 and the terminal group 103. The terminal group 103 may be comprised of a plurality of terminal apparatuses 102. The terminal apparatus 102 and each of the terminal apparatuses 102 in the terminal group 103 can be computer terminals that are used by users in their daily work. The first electronic device 105 and the second electronic device 106 described above can be, for example, image forming apparatuses. The third electronic device 107 can be, for example, an air conditioner. Note that the electronic devices connected to the network 101 are not limited to the above-described three electronic devices 105 to 107. The above-described electronic devices 102 to 107 are capable of sending and receiving data across the network 101.

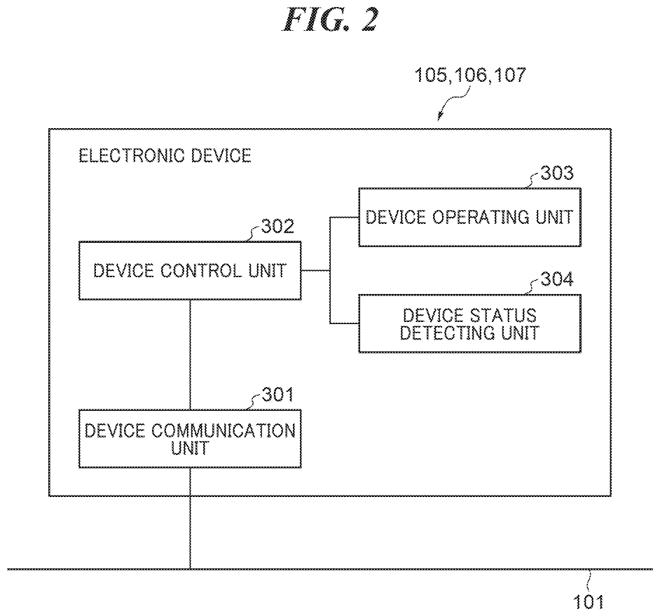

FIG. 2 is a view useful in explaining a basic configuration of the electronic devices 105 to 107 in FIG. 1. The electronic device in FIG. 2 has a device communication unit 301, a device operating unit 303, a device status detecting unit 304, and a device control unit 302 to which they are connected. The device operating unit 303 operates to perform the functions of the electronic device itself. In a case where the electronic device is, for example, an image forming apparatus, the device operating unit 303 prints images on recording media such as sheets and reads and copies images. In a case where the electronic device is an air conditioner, the device operating unit 303 operates a compressor, a fan, and so forth. The device status detecting unit 304 detects the operational status of the device operating unit 303. Examples of the operational status of the device operating unit 303 include running and suspended. Examples of the operational status of the device operating unit 303 may also include a busy status in which other processing cannot be performed. The device status detecting unit 304 can also detect detailed information about the operational status of the device operating unit 303.

In a case where the electronic device is an image forming apparatus, the device status detecting unit 304 can detect such information as a job currently in process, an unprocessed job, and an estimated remaining execution time period as detailed information about the operational status of the device operating unit 303. In a case where the electronic device is an air conditioner, the device status detecting unit 304 can detect such information as a set temperature and a present temperature as detailed information about the operational status of the device operating unit 303. The device communication unit 301 sends and receives data to and from the other devices connected to the network 101. The device communication unit 301 can send and receive data including information about operation commands, status notifications, and so forth to and from, for example, the terminal apparatus 102.

The device communication unit 301 has a memory which stores programs and others, and a CPU. The device communication unit 301 is implemented in the electronic device by the CPU reading out and executing the programs stored in the memory. The device communication unit 301 controls the overall operation of the electronic device. The device communication unit 301 can be an external controller formed separately from the main body of the electronic device and used in a state of being connected to the main body of the electronic device. The device communication unit 301 can be configured to communicate with a control unit in the main body of the electronic device by infrared or the like. For example, when the operational status of the device operating unit 303 detected by the device status detecting unit 304 has changed, the device communication unit 301 sends information about the changed operational status from the device communication unit 301 to the terminal apparatus 102 or the like. Moreover, upon receiving an operation command from the terminal apparatus 102, the device communication unit 301 controls the device operating unit 303 according to the operation command.

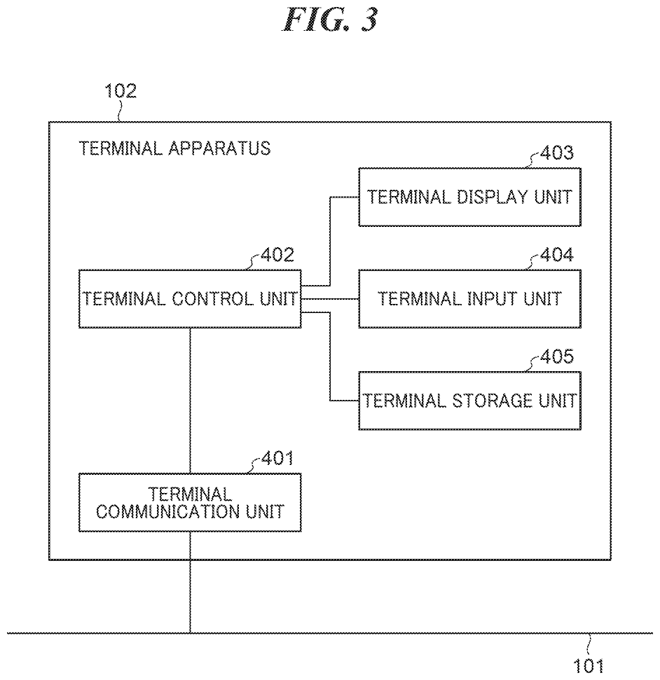

FIG. 3 is a view useful in explaining a basic configuration of the terminal apparatus 102 in FIG. 1. The terminal apparatus 102 in FIG. 3 has a terminal communication unit 401, a terminal display unit 403, a terminal input unit 404, a terminal storage unit 405, and a terminal control unit 402 to which they are connected. The terminal communication unit 401 sends and receives data to and from the other devices connected to the network 101. The terminal communication unit 401 can use either a wireless communication method or a wired communication method. The terminal communication unit 401 can send and receive data including information about operation commands, status notifications, and so forth to and from the device communication unit 301 of the electronic devices. The terminal display unit 403 can be, for example, a liquid crystal panel. The terminal input unit 404 can be a transparent touch panel that is overlaid on the liquid crystal panel. The terminal display unit 403 and the terminal input unit 404 can constitute a user interface that provides information to the user of the terminal apparatus 102 and receives user operations. The terminal storage unit 405 is, for example, a semiconductor memory. The terminal storage unit 405 stores programs and various types of data for controlling the operation of the terminal apparatus 102. The terminal storage unit 405 can store, for example, details of a simultaneous operation command, which will be described later, and the address of the server apparatus 104.

The terminal control unit 402 is, for example, a CPU. The terminal control unit 402 reads out and executes the programs stored in the terminal storage unit 405. As a result, the terminal control unit 402 is implemented in the terminal apparatus 102. For example, when the terminal communication unit 401 receives a notification about the status of the electronic device, the terminal control unit 402 displays the detail of the received notification on the terminal display unit 403. The terminal control unit 402 further displays a screen for remotely controlling (remotely operating) the electronic device, a screen for setting remote control (remote operation), or the like on the terminal display unit 403. Then, based on an operation performed on the screen by the user, the terminal control unit 402 generates setting information for remotely controlling the electronic device, an operation command for remotely controlling the electronic device, and so forth, and sends them through the terminal communication unit 401.

As described above, the communication system 100 in FIG. 1 has the terminal apparatus 102, the plurality of the electronic devices 105 to 107, which is capable of receiving commands from the terminal apparatus 102, and so forth. The user is able to use the terminal apparatus 102 such as a smartphone to monitor the statuses of the electronic devices connected to the network 101 in the communication system 100 and operate the electronic devices.

However, in a case where the user operates each of the electronic devices with the terminal apparatus 102 and the terminal apparatus 102 receives status notifications from the respective electronic devices and displays them, it takes a lot of time and effort for the user to perform operation and checking. Particularly, if there are many electronic devices to be operated with the terminal apparatus 102, and the user operates the electronic devices collectively (at a time) one by one in order, the user needs to check notifications, which are displayed for the respective electronic devices in random order, one by one. In order to check whether or not all of the electronic devices operated at once are in desired statuses, the user needs to check individual notifications for the respective electronic devices one by one. Moreover, every time the user performs an operation, he or she needs to determine whether or not he or she has already checked notifications about all of the electronic devices which he or she operated. Thus, for the communication system 100 including the terminal apparatus 102 and the electronic devices capable of receiving commands from the terminal apparatus 102, there is a demand to reduce the burden of operation and checking on the user even if there are many electronic devices to be operated with the terminal apparatus 102.

Accordingly, in the present embodiment, the server apparatus 104 is added to the communication system 100. The terminal apparatus 102 and the plurality of electronic devices are capable of sending and receiving operation commands and status notifications through the server apparatus 104. Moreover, the terminal apparatus 102 is capable of sending simultaneous operation command to the server apparatus 104. Here, the simultaneous operation command means an operation command for the user to operate the plurality of electronic devices by a single operation on the terminal apparatus 102. A detailed description thereof will be given below.

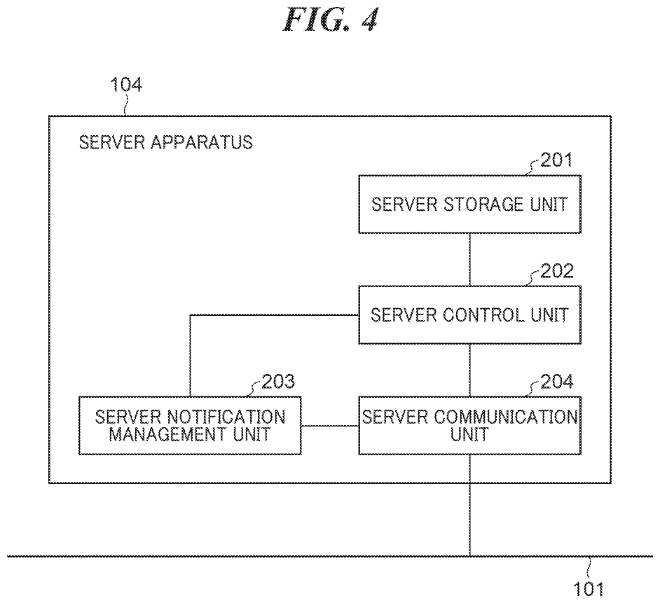

FIG. 4 is a view useful in explaining a basic configuration of the server apparatus 104 in FIG. 1. The server apparatus 104 in FIG. 4 has a server communication unit 204, a server notification management unit 203, a server storage unit 201, and a server control unit 202 to which they are connected. The server communication unit 204 sends and receives data to and from the other devices connected to the network 101. The server communication unit 204 can act as a communication means for sending and receiving operation commands, status notifications, and so forth to and from the terminal apparatus 102 and the plurality of electronic devices. The server notification management unit 203 manages notifications about the statuses of electronic devices sent and received by the server communication unit 204. The server notification management unit 203 obtains, for example, status notifications received from the electronic devices by the server communication unit 204 and sends status notifications based on them to the terminal apparatus 102 through the server communication unit 204. The server storage unit 201 is, for example, a semiconductor memory. The server storage unit 201 stores programs for controlling the operation of the server apparatus 104 and various types of data. The server storage unit 201 can store, for example, the addresses of the electronic devices included in the communication system 100 and the address of the terminal apparatus 102.

The server control unit 202 is, for example, a CPU. The server control unit 202 reads out and executes the programs stored in the server storage unit 201. As a result, the server control unit 202 and the server notification management unit 203 are implemented as control means in the server apparatus 104. It is noted that although the server notification management unit 203 is one of functions of the server control unit 202, it is described as a unit different from the server control unit 202 in the present embodiment for explanatory convenience. For example, when the server communication unit 204 receives the simultaneous operation command, the server control unit 202 causes the server storage unit 201 to store the details of the simultaneous operation command and sends operation commands to the electronic devices to be subjected to the simultaneous operation command through the server communication unit 204. When the server communication unit 204 receives status notifications from the electronic devices, the server control unit 202 determines whether or not the received status notifications correspond to the simultaneous operation command. When the received status notifications correspond to the simultaneous operation command, the server control unit 202 registers the status notifications in the server notification management unit 203 and causes the server storage unit 201 to store the status notifications as necessary.

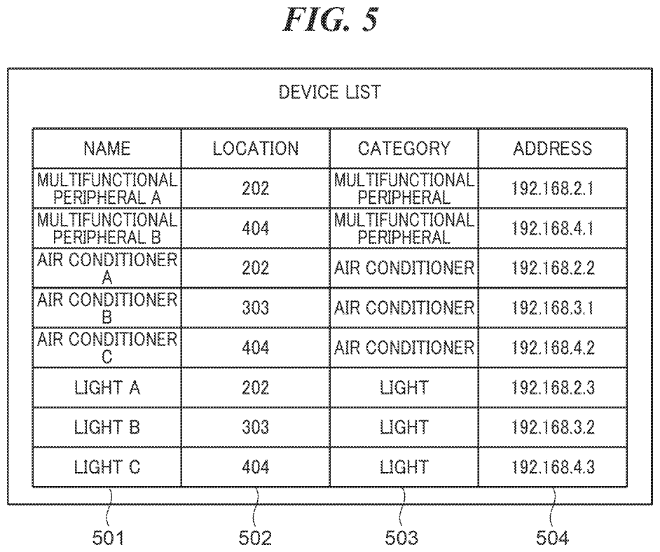

FIG. 5 is a view showing an example of a list of electronic devices capable of being remotely controlled through the server apparatus 104 in FIG. 4. The list of electronic devices in FIG. 5 includes concrete examples of the electronic devices 105 to 107 in FIG. 1, including a multifunctional peripheral A, a multifunctional peripheral B, an air conditioner A, an air conditioner B, an air conditioner C, a light A, a light B, and a light C. The list of electronic devices in FIG. 5 also includes information on the electronic devices, including names 501, installation locations 502, categories 503, and network addresses 504. Names unique to the respective electronic devices in the communication system 100 can be registered as the names 501 of the respective electronic devices. Names of installation locations where the respective electronic devices are installed can be registered as the installation locations 502. Group names which represent the types of the respective electronic devices can be registered as the categories 503. Addresses unique to the respective electronic devices in the communication system 100 can be registered as the network addresses 504. It is noted that the list of electronic devices can also include, for example, the registration dates of the respective electronic devices.

The list of electronic devices described above can be stored in the server storage unit 201 of the server apparatus 104. The terminal apparatus 102 can request the server apparatus 104 to send the list of electronic devices, and in response to the request, the server apparatus 104 can send data of the list of electronic devices to the terminal apparatus 102. The server apparatus 104 can cause the server storage unit 201 to store the list of electronic devices such that it can be updated by the terminal apparatus 102, the terminal group 103, or each electronic device. The list of electronic devices described above is a list of electronic devices capable of being operated through the server apparatus 104 in accordance with the simultaneous operation command.

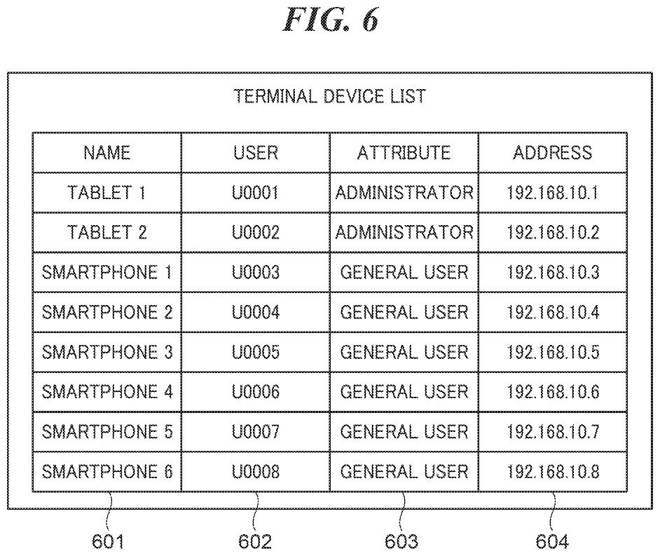

FIG. 6 is a view showing an example of a list of terminal apparatuses 102 capable of remotely controlling the electronic devices through the server apparatus 104 in FIG. 4. The list of terminal apparatuses 102 in FIG. 6 includes a tablet 1, a tablet 2, and smartphones 1 to 6 as concrete examples of the terminal apparatuses 102 (and the terminal group 103) in FIG. 1. The list of terminal apparatuses 102 in FIG. 6 also includes names 601, users 602, attributes 603, network addresses 604 as information on the terminal apparatuses 102. Names unique to the respective terminal apparatuses 102 in the communication system 100 can be registered as the names 601 of the respective terminal apparatuses 102. IDs of users who use the respective terminal apparatuses 102 can be registered as the users 602. Administrator users or general users as the attributes of users who are using the respective terminal apparatuses 102 can be registered as the attributes 603. It is noted that the attributes of the terminal apparatuses 102 can also be registered as the attributes 603 of the terminal apparatuses 102. Addresses unique to the respective terminal apparatus 102 in the communication system 100 can be registered as the network addresses 604.

The list of terminal apparatuses 102 described above can be stored in the server storage unit 201 of the server apparatus 104. The server apparatus 104 can cause the server storage unit 201 to store the list of terminal apparatuses 102 such that it can be updated by the terminal apparatus 102, the terminal group 103, or each electronic device. The list of terminal apparatuses 102 described above is a list of terminal apparatuses 102 capable of being operated through the server apparatus 104 in accordance with the simultaneous operation command.

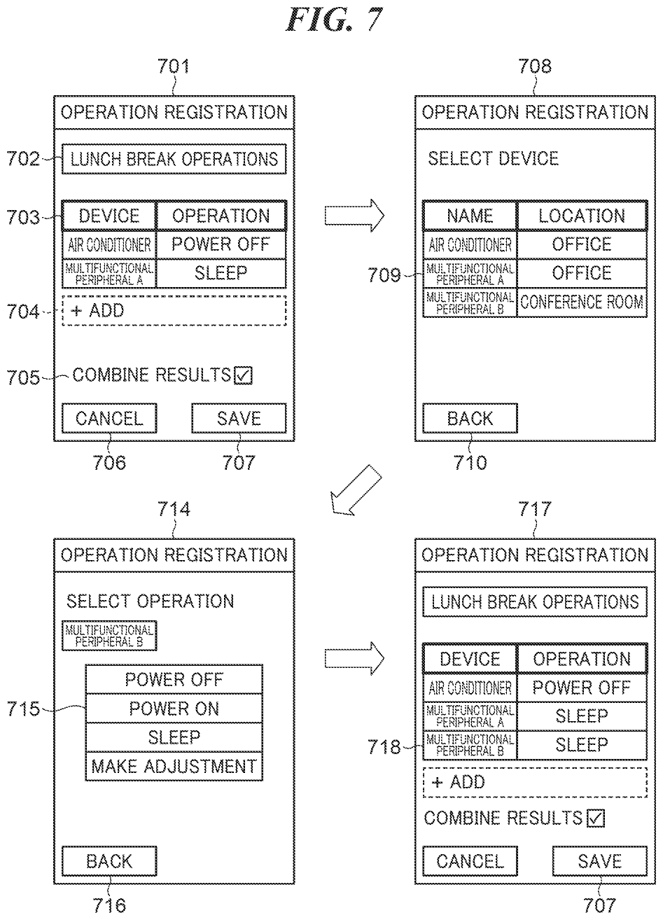

FIG. 7 is a view useful in explaining an example of transition of screens to be displayed on the terminal apparatus 102 in FIG. 3 when simultaneous operations are registered in the server apparatus 104 in FIG. 4. FIG. 7 illustrates a simultaneous operation registration screen 701, which is being operated, a device selection screen 708, and an operation selection screen 714, as and a simultaneous operation registration screen after operation 717 are illustrated as a series of operating screens displayed on the terminal apparatus 102 such that they can be operated to register simultaneous operations. For the user to newly register or change simultaneous operations with the terminal apparatus 102, the terminal control unit 402 of the terminal apparatus 102 displays the screens shown in FIG. 7 on the terminal display unit 403 and also controls screen transitions to generate information for simultaneous operations.

A simultaneous operation name 702, a list of registered operations 703, an add button 704, a result combining setting 705, a cancel button 706, and a save button 707 are allocated to the simultaneous operation registration screen 701. A registered name for simultaneous operations to be set, for example “Lunch break operations”, is input as the simultaneous operation name 702. By operating the simultaneous operation name 702, the user can display a registration name input window and input a desired simultaneous operation name. A plurality of electronic devices registered for the simultaneous operations is displayed in list form in the registered operation list 703. Here, an air conditioner and a multifunctional peripheral A, which are electronic devices, are displayed in list form. The details of the simultaneous operations are also displayed in association with the respective electronic devices. Operation commands corresponding to the details of the operation are sent from the server apparatus 104 to the displayed electronic devices.

The add button 704 is a button that is operated to add an electronic device to be operated in the simultaneous operations. By the add button 704 being operated, the screen displayed on the terminal apparatus 102 transitions to the device selection screen 708. The result combining setting 705 is a toggle-type button used for selecting whether or not to combine notifications about the statuses after the operations of the plurality of electronic devices registered for the simultaneous operations. When the button is checked (is ON), notifications about the statuses after the operations of the plurality of electronic devices registered for the simultaneous operations are combined together in the server apparatus 104 and sent to the electronic devices. When the button is not checked (is OFF), notifications about the statuses after the operation of the plurality of electronic devices registered for the simultaneous operations are individually sent from the server apparatus 104 to the electronic devices. The cancel button 706 is a button that is operated to cancel the registration of simultaneous operations.

A list 709 of options of an electronic device to be additionally registered, and a back button 710 are allocated to the device selection screen 708. A screen sub item name “Operation registration” is also allocated to the device selection screen 708. Names and information about installation locations of electronic devices included in the communication system 100 are displayed in the list 709 of options of an electronic device to be additionally registered. Information on the plurality of electronic devices included in the list of electronic devices in FIG. 5, which is stored in the server storage unit 201 of the server apparatus 104, can be displayed in the list 709 of options of an electronic device to be additionally registered. Here, the names and the information about installation locations of the respective electronic devices are displayed. By one electronic device being selected from the list 709 of options of an electronic device to be additionally registered, the screen displayed on the terminal apparatus 102 transitions to the operation selection screen 714. The back button 710 is a button that is operated to cancel the addition of an electronic device. In this case, the screen displayed on the terminal apparatus 102 transitions to the simultaneous operation registration screen 701.

An operation list 715 and a back button 716 are allocated to the operation selection screen 714. A screen sub item name “Operation registration” is also allocated to the operation selection screen 714. The operation list 715 is a list of operation commands that can be sent to the electronic devices, which has been selected on the device selection screen 708, by remote control. Here, “Power OFF”, “Power ON”, “Sleep”, and “Make adjustment” are displayed as examples of the operation commands for remote control of “Multifunctional peripheral B” selected on the device selection screen 708. By one operation command being selected from the operation list 715, the screen displayed on the terminal apparatus 102 transitions to the simultaneous operation registration screen after operation 717. The back button 716 is a button that is operated to cancel the addition of an operation command. In this case, the screen displayed on the terminal apparatus 102 transitions to the device selection screen 708.

Information similar to that of the simultaneous operation registration screen 701 is allocated to the simultaneous operation registration screen after operation 717. However, the operation command “Sleep” for the “Multifunctional peripheral B” selected on the device selection screen 708 and the operation selection screen 714 are added to a list of registered operations 718.

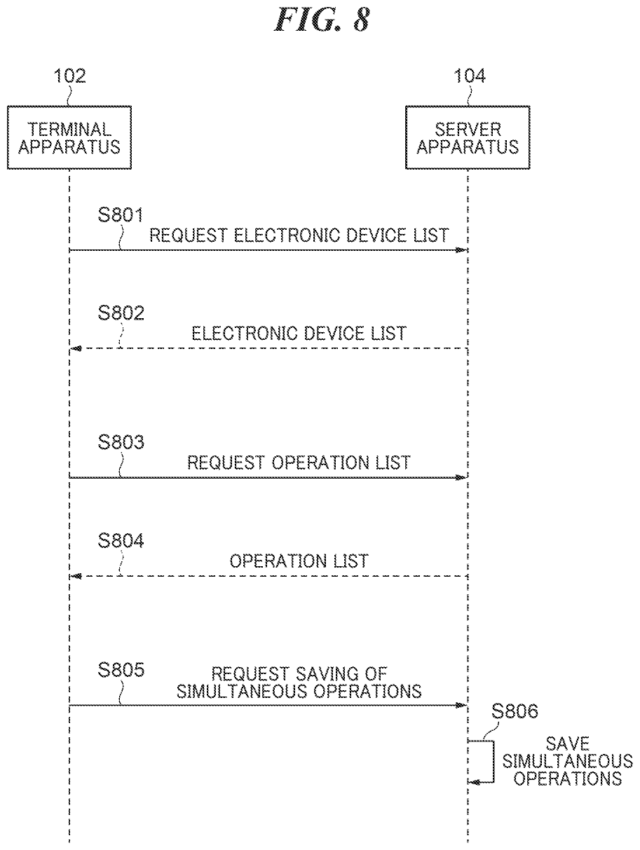

FIG. 8 is a view showing an example of a sequence that is executed when simultaneous operations are registered by the terminal apparatus 102 and the server apparatus 104. FIG. 8 shows the terminal apparatus 102 which is operated by the user to register simultaneous operations, and the server apparatus 104 in which the simultaneous operations are registered. The time flows from the top to the bottom of the figure. It is noted that the sequence in FIG. 8 for the registration of simultaneous operations can be executed by the electronic device and the server apparatus 104.

When the user starts an operation to register simultaneous operations on the simultaneous operation registration screen 701, the terminal control unit 402 of the terminal apparatus 102 sends a request for information on a list of electronic devices from the terminal communication unit 401 to the server apparatus 104 (step S801). In the server apparatus 104, when the server communication unit 204 receives the request for the information on the list of electronic devices, the server control unit 202 loads, for example, the list of electronic devices in FIG. 5 from the server storage unit 201. Then, the server control unit 202 sends the loaded list of electronic devices from the server communication unit 204 to the terminal apparatus 102 (step S802). In the terminal apparatus 102, when the terminal communication unit 401 receives the list of electronic devices, the terminal control unit 402 displays the device selection screen 708, on which the information on the list is laid out, on the terminal display unit 403.

When the user selects one electronic device on the displayed device selection screen 708, the terminal control unit 402 sends a request for information on operation commands (operation list) for the selected electronic device to the server apparatus 104 through the terminal communication unit 401 (step S803). When the server communication unit 204 receives the request for the information on the operation commands, the server control unit 202 loads information on operation commands, which can be sent to the selected electronic device, from the server storage unit 201. The server control unit 202 then sends the loaded information on the operation commands to the terminal apparatus 102 through the server communication unit 204 (step S804). In the terminal apparatus 102, when the terminal communication unit 401 receives the information on the one or more operation commands, the terminal control unit 402 displays the operation selection screen 714, on which the information on the one or more operation commands is laid out, on the terminal display unit 403. When the user selects one operation command on the operation selection screen 714, the terminal control unit 402 selects the operation command selected by the user as an operation command to be used for a simultaneous operation on the selected electronic device. It is noted that the processes in the step S803 and the step S804 can be omitted for the electronic devices for which operation commands have already been registered on the simultaneous operation registration screen 701.

After selecting a plurality of electronic devices to be simultaneously operated and operation commands to be executed by the respective electronic devices, the user operates, for example, the save button 707 on the simultaneous operation registration screen 717. In this case, the terminal control unit 402 sends all information for the simultaneous operations which have ever been selected to the server apparatus 104 through the terminal communication unit 401 (sends a request saving of simultaneous operations) (step S805). In the server apparatus 104, when the server communication unit 204 receives all of the information for the simultaneous operations, the server control unit 202 stores all of the received information for the simultaneous operations in the server storage unit 201. The server control unit 202 newly stores all of the received information for the simultaneous operations in the server storage unit 201 or updates information that has already been registered by all of the received information for the simultaneous operations (step S806). Thus, the information for the simultaneous operations (or new information on simultaneous operations) is stored in the server storage unit 201 of the server apparatus 104. The information for the simultaneous operations includes such information as the simultaneous operation name 702, the details of the operation list 703, and the result combining setting 705. The server storage unit 201 stores the simultaneous operation command (batch operation command) associated using the terminal apparatus 102 and the information on the operation commands to be sent to the respective electronic devices.

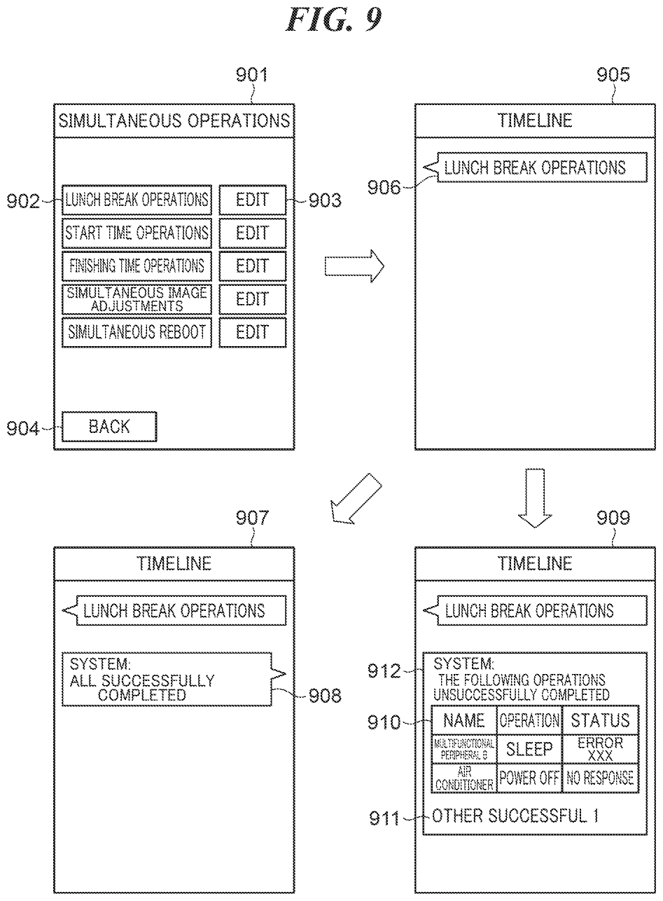

A description will now be given of simultaneous operations, which are performed from the terminal apparatus 102 using information on the simultaneous operations stored in the server apparatus 104. FIG. 9 is a view useful in explaining an example of transition of screens displayed when the simultaneous operations are performed in the terminal apparatus 102 in FIG. 3. FIG. 9 shows a simultaneous operation command execution screen 901, a first timeline screen 905, a second timeline screen 907, and a third timeline screen 909 are illustrated as a series of operating screens displayed on the terminal apparatus 102 for simultaneous operations such that they can be operated. When the user performs simultaneous operations from the terminal apparatus 102, the terminal control unit 402 of the terminal apparatus 102 displays the screens in FIG. 9 or the like on the terminal display unit 403, and performs processing for simultaneous operations while controlling the transitions of screens displayed on the terminal display unit 403.

A list of simultaneous operations 902, edit buttons 903, and a back button 904 are allocated to the simultaneous operation command execution screen 901. A plurality of registered simultaneous operations, which can be used in the terminal apparatus 102, are displayed in list form by their respective simultaneous operation names in the simultaneous operations list 902. A plurality of simultaneous operations stored in the terminal storage unit 405 of the terminal apparatus 102 can be displayed in list form in the list of simultaneous operations 902. On the right sides of the respective simultaneous operation names, the respective edit buttons 903 are correspondingly placed.

When the user operates one simultaneous operation name in the list of simultaneous operations 902, the terminal control unit 402 of the terminal apparatus 102 generates a simultaneous operation command corresponding to the operated one simultaneous operation name and sends the simultaneous operation command to the server apparatus 104 through the terminal communication unit 401. The screen displayed on the terminal apparatus 102 transitions to the first timeline screen 905. When the user operates one of the edit buttons 903, the terminal control unit 402 of the terminal apparatus 102 displays the simultaneous operation registration screen 701 for simultaneous operations corresponding to the operated edit button 903 on the terminal display unit 403. The the user can edit, through the operation described above with reference to FIG. 7, the details of the simultaneous operations via the simultaneous operation registration screen 701. When the user operates the back button 904, the terminal control unit 402 of the terminal apparatus 102 ends the control for simultaneous operations without generating any simultaneous operation command.

The timeline screens are screens that display simultaneous operations performed by the user with the terminal apparatus 102, notifications of their results, and so forth in chronological order. For example, a simultaneous operation name 906 of the simultaneous operations “Lunch break operations”, which has been operated on the simultaneous operation command execution screen 901, is displayed on the first timeline screen 905. The terminal control unit 402 can display the simultaneous operation name 906 for “Lunch break operations” on the first timeline screen 905 after sending a simultaneous operation command for “Lunch break operation”.

The second timeline screen 907 is a timeline screen to which the first timeline screen 905 transitions. A result of simultaneous operations 908 is additionally included in the second timeline screen 907. The terminal control unit 402 can add the result of simultaneous operations 908 to the timeline screen based on a notification of a result received by the terminal communication unit 401 after the simultaneous operation command for “Lunch break operation” being sent. As a result, the user can see that all operations of electronic devices in accordance with the simultaneous operation command for “Lunch break operations” have been successfully performed. The terminal control unit 402 can output a notification sound or the like when updating the timeline screen. Thus, even when a plurality of electronic devices are operated by simultaneous operations, the simultaneous operation result 908, which indicates the results of operations on the plurality of electronic devices as one, can be displayed on the second timeline screen 907 displayed on the terminal apparatus 102.

The third timeline screen 909 is another timeline screen to which the first timeline screen 905 transitions. A result of simultaneous operations 912 additionally included in the third timeline screen 909. The terminal control unit 402 can add the result of simultaneous operations 912 to the timeline screen based on a notification of a result received by the terminal communication unit 401 after the simultaneous operation command for “Lunch break operation” being sent. The result of simultaneous operations 912 indicates that at least one of operations for a plurality of electronic devices in accordance with the simultaneous operation command for “Lunch break operations” has not been successfully performed. The result of simultaneous operations 912 includes a list of unsuccessful operations 910 and the number of successful operations 911. The list of unsuccessful operations 910 includes the names of electronic devices that have not been successfully operated, the details of said operations, and their statuses.

In this way, the user can recognize the electronic devices that have not been successfully performed in accordance with the simultaneous operation command and the causes of unsuccessful operations. The terminal control unit 402 can output a notification sound or the like when updating the timeline screen. By the user selecting one from the list of unsuccessful operations 910, the terminal control unit 402 can display further detailed information on the unsuccessful operation. Thus, even when a plurality of electronic devices are operated by simultaneous operations, the result of simultaneous operations 912, which indicates the results of operations on the plurality of electronic devices as one, can be displayed on the third timeline screen 909 displayed on the terminal apparatus 102.

The result of simultaneous operations 912, which indicates the results of operations on the plurality of electronic devices as one, includes at least the individual statuses of the electronic devices that have not successfully executed operation commands. By the user selecting one from the list of unsuccessful operations 910, the terminal control unit 402 can generate an operation command related to a failure in the selected electronic device by itself and send it to the selected electronic device. As a result, upon checking the third timeline screen 909, the user can perform remote control again so as to bring the electronic device that has not successfully executed the operation command into a state where it has successfully executed the operation command. It is noted that the operation command related to the failure may be either sent to the electronic device directly from the terminal control unit 402 or sent to the electronic device through the server apparatus 104.

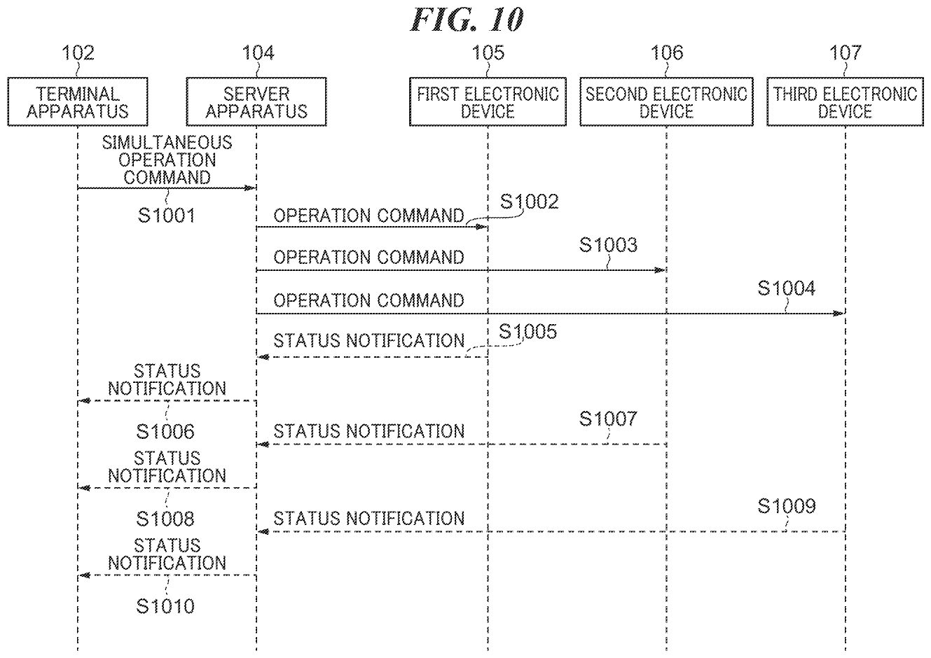

FIG. 10 is a view showing an example of a sequence of simultaneous operations in the communication system 100, which is executed by an operation on the terminal apparatus 102 in FIG. 9 in a case where the result combining setting 705 is OFF. In FIG. 10, the terminal apparatus 102, the server apparatus 104, the first electronic device 105, the second electronic device 106, and the third electronic device 107 in the communication system 100 are illustrated. The time flows from the top to the bottom of the figure.

In response to an operation performed for simultaneous operations by the user, the terminal control unit 402 of the terminal apparatus 102 sends a simultaneous operation command to the server apparatus 104 (step S1001). The server control unit 202 of the server apparatus 104 that has received the simultaneous operation command interprets the received simultaneous operation command and sends operation commands for the simultaneous operations to respective electronic devices related to the simultaneous operations (steps S1002, S1003, S1004). The first electronic device 105 receives the operation command sent to the first electronic device 105 itself and executes the received operation command (performs processing based on the received operation command). Then, the first electronic device 105 sends a notification (status notification) indicating its status after the execution of the operation command to the server apparatus 104, which is a sender of said operation command (step S1005). The second electronic device 106 receives the operation command sent to the second electronic device 106 itself and executes the received operation command. Then, the second electronic device 106 sends a notification (status notification) indicating its status after the execution of the operation command to the server apparatus 104, which is a sender of said operation command (step S1007). The third electronic device 107 receives the operation command sent to the third electronic device 107 itself and executes the received operation command. Then, the third electronic device 107 sends a notification (status notification) indicating its status after the execution of the operation command to the server apparatus 104, which is a sender of said operation command (step S1009).

Thus, the server apparatus 104 sends operation commands to a plurality of electronic devices related to simultaneous operations and afterwards receives respective notifications about their statuses from the respective electronic devices. For FIG. 10, the result combining setting 705 for simultaneous operations is OFF. In this case, upon receiving notifications about the statuses of respective electronic devices from the respective electronic devices, the server control unit 202 of the server apparatus 104 sends the received status notifications to the terminal apparatus 102, which is a sender of the simultaneous operation command, individually in order (steps S1006, S1008, S1010). It is noted that the server control unit 202 of the server apparatus 104 can send the notifications about the statuses of the respective electronic devices to the terminal group 103 in the communication system 100 as well.

In this case, the terminal apparatus 102 receives, for each electronic device, a notification about status after the execution of the simultaneous operations, of the plurality of electronic devices. The terminal control unit 402 of the terminal apparatus 102 adds the received status notifications to the timeline screen in the order in which they were received. As a result, the status after the execution of the simultaneous operations, of the electronic devices related to the simultaneous operations, is displayed on the timeline screens on the terminal apparatus 102 for each electronic device, as is distinct from FIG. 9. To check whether or not the simultaneous operations have been successfully performed for all of the electronic devices related to the simultaneous operations, the user needs not only to individually check the statuses of the respective electronic devices after the respective executions but also to check whether or not the same number of notifications as the number of electronic devices subjected to the simultaneous operations have already been received, and so forth.

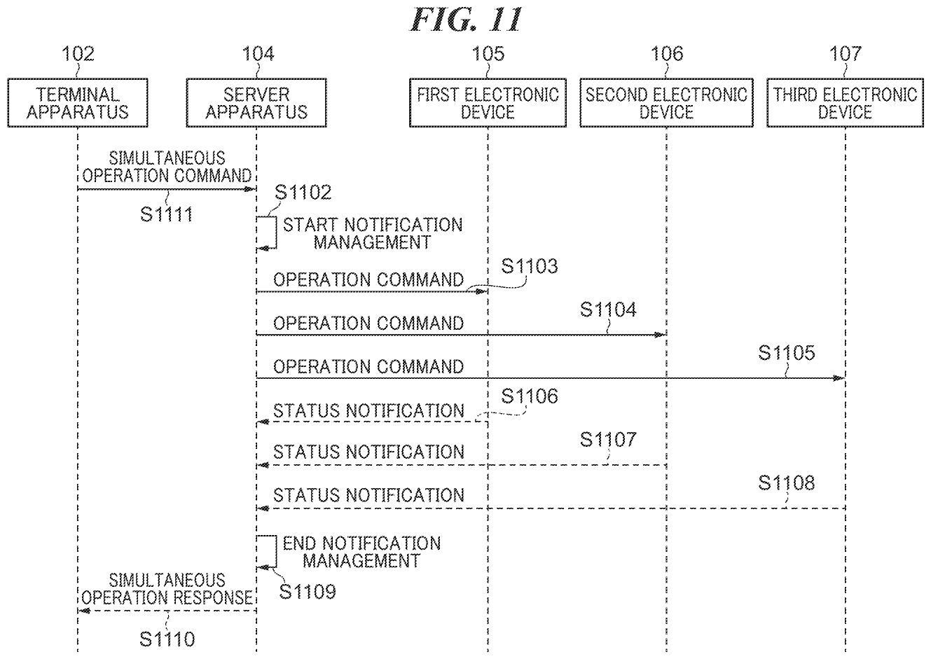

FIG. 11 is a view showing an example of a sequence of simultaneous operations in the communication system 100, which is executed by an operation on the terminal apparatus 102 in FIG. 9 in a case where the result combining setting 705 is ON. In FIG. 11, similar to FIG. 10, the terminal apparatus 102, the server apparatus 104, the first electronic device 105, the second electronic device 106, and the third electronic device 107 in the communication system 100 are illustrated. The time flows from the top to the bottom of the figure.

In response to an operation performed for simultaneous operations by the user, the terminal control unit 402 of the terminal apparatus 102 sends a simultaneous operation command to the server apparatus 104 (step S1111). The server control unit 202 of the server apparatus 104 that has received the simultaneous operation command interprets the received simultaneous operation command and sees that the result combining setting 705 is ON. The server control unit 202 then stores the details of the simultaneous operation command in the server storage unit 201 and starts notification management for the simultaneous operation command (steps S1102).

The server control unit 202 sends respective operation commands for the simultaneous operations to the respective electronic devices related to the simultaneous operations (steps S1103, S1104, S1105). The first electronic device 105 receives the operation command sent to the first electronic device 105 itself and executes the received operation command (performs processing based on the received operation command). Then, the first electronic device 105 sends a notification (status notification) indicating its status after the execution of the operation command to the server apparatus 104, which is a sender of said operation command (step S1106). The second electronic device 106 receives the operation command sent to the second electronic device 106 itself and executes the received operation command. Then, the second electronic device 106 sends a notification (status notification) indicating its status after the execution of the operation command to the server apparatus 104, which is a sender of said operation command (step S1107). The third electronic device 107 receives the operation command sent to the third electronic device 107 itself and executes the received operation command. Then, the third electronic device 107 sends a notification (status notification) indicating its status after the operation command is executed to the server apparatus 104, which is a sender of said operation command (step S1108). Thus, the server apparatus 104 sends operation commands to a plurality of electronic devices related to simultaneous operations and afterwards receives respective notifications about their statuses from the respective electronic devices.

When the server apparatus 104 receives a status notification, the server control unit 202 determines whether or not it is a status notification from an electronic device included in the simultaneous operation command under the notification management. Then, upon determining that it is a status notification from an electronic device included in the simultaneous operation command under the notification management, the server control unit 202 stores the details of the status notification in the server storage unit 201 without providing notification of the status to the terminal apparatus 102 based on the reception of the status notification. The server control unit 202 also determines whether or not status notifications have been received from all of the electronic devices included in the simultaneous operation command under the notification management. Then, upon determining that status notifications have been received from all of the electronic devices, the server control unit 202 ends the notification management for the simultaneous operation command (step S1109) and sends a notification about the result of the simultaneous operation command as a response (simultaneous operation response) to the terminal apparatus 102 (step S1110). It is noted that the server control unit 202 of the server apparatus 104 can send the notification about the result of the simultaneous operation command to the terminal group 103 in the communication system 100 as well. The server control unit 202 can send the notification about the result of the simultaneous operation command to only a specific terminal apparatus 102 in the terminal group 103 in the communication system 100.

In this case, the terminal apparatus 102 receives the statuses after the execution, of the plurality of electronic devices related to the simultaneous operations, as one notification. The terminal control unit 402 of the terminal apparatus 102 adds the received one notification to the timeline screen. As a result, the statuses after the execution, of the plurality of electronic devices related to the simultaneous operations are displayed as one notification on the timeline screen on the terminal apparatus 102, as illustrated in FIG. 9. The user is able to easily check whether or not the simultaneous operations have been successfully performed for all of the electronic devices related to the simultaneous operations just by checking information included in the one notification.

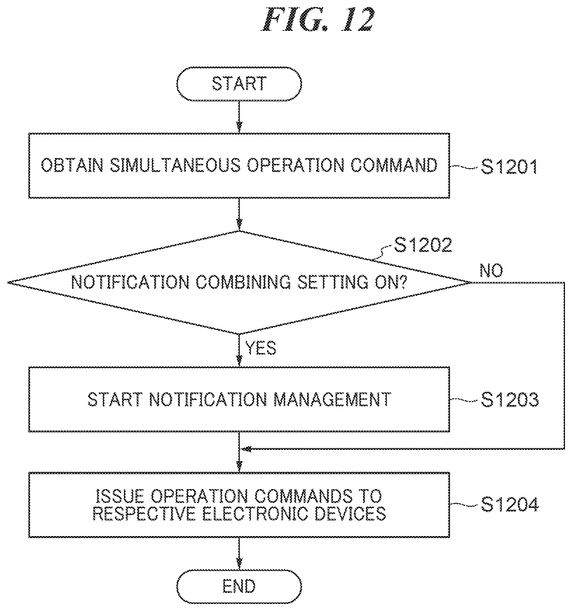

FIG. 12 is flowchart showing how the server apparatus 104 in FIG. 4 controls the execution of simultaneous operations. The server control unit 202 of the server apparatus 104 can repeatedly control the execution of simultaneous operations shown in FIG. 12 every time a reception of a simultaneous operation command.

In step S1201, the server control unit 202 obtains a simultaneous operation command (simultaneous operation instruction), which has been received from the terminal apparatus 102 by the server communication unit 204 of the server apparatus 104, from the server communication unit 204. In step S1202, the server control unit 202 interprets the obtained simultaneous operation command and determines whether or not the result combining setting (notification combining setting) is ON. When determining that the result combining setting is ON, the server control unit 202 proceeds the process to step S1203. When determining that the result combining setting is OFF, the server control unit 202 proceeds the process to the step S1204.

In the step S1203, the server control unit 202 starts notification management for the simultaneous operation command to collectively send notifications after the operation commands are executed in a plurality of electronic devices related to the simultaneous operations to the terminal apparatus 102. The server control unit 202 causes the server storage unit 201 to store information on the plurality of electronic devices subjected to the simultaneous operations and information on the details of operations by said electronic devices, together with the time at which the simultaneous operation command was received. In step S1204, the server control unit 202 sends (issues) operation commands to the respective electronic devices related to the simultaneous operations through the server communication unit 204. Here, the server control unit 202 can carry out operation command sending processes for all of the the plurality of electronic devices related to the simultaneous operations at the same time or carry out respective operation command sending processes for some of the electronic devices prior to respective operation command sending processes for the other electronic devices.

For example, in some cases, at the timing when the process in the step S1204 is carried out, the plurality of electronic devices related to the simultaneous operation command may include an electronic device stopped and/or an electronic device in a busy status. To cope with this, the server control unit 202 can collect information on the statuses of the respective electronic devices in advance, send operation commands to only electronic devices which are already ready to execute the operation commands, and after that, send operation commands to the other electronic devices which are going to be ready to execute the operation commands. For an electronic device to which an operation command has not been sent, the server control unit 202 can repeatedly send the operation command to this electronic device. For example, for an electronic device to which an operation command has not been sent, the server control unit 202 can repeatedly obtain its status at regular time intervals, and when the electronic device becomes ready to execute the operation command, send the operation command to this electronic device. After that, the server control unit 202 ends the process in FIG. 12.

Thus, the server apparatus 104 is able to obtain a simultaneous operation command received from the terminal apparatus 102, and based on the obtained simultaneous operation command and information in the server storage unit 201, send operation commands to the respective ones of the plurality of electronic devices related to the simultaneous operation command.

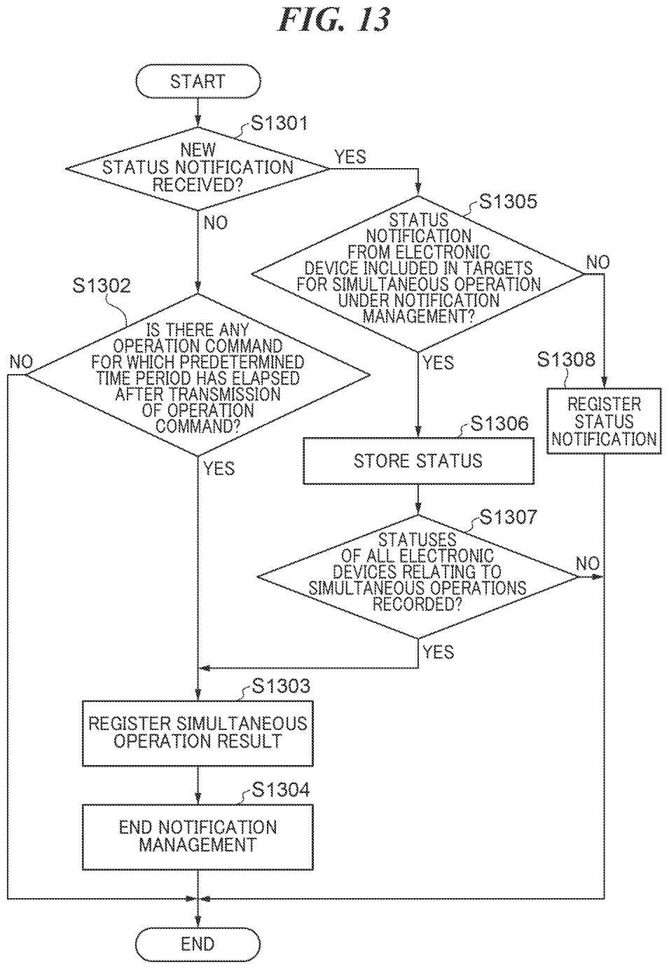

FIG. 13 is flowchart showing how the server apparatus 104 in FIG. 4 controls the notification of simultaneous operations. The server control unit 202 of the server apparatus 104 that has already started notification management for a simultaneous operation command can repeatedly control the notification of simultaneous operations shown in FIG. 13 at regular time intervals while waiting for status notifications from the plurality of electronic devices related to the simultaneous operations.

In step S1301, the server control unit 202 determines whether or not the server communication unit 204 has received a new status notification about a status after the execution of an operation command from an electronic device. When determining that a new status notification was received after the previous execution of the step S1301, the server control unit 202 proceeds the process to step S1305. When determining that no new status notification has been received, the server control unit 202 proceeds the process to step S1302. In the step S1302, the server control unit 202 determines whether or not there is any electronic device in which a predetermined time period has elapsed after an operation command is sent, among the plurality of electronic devices related to simultaneous operations under notification management (namely, the server control unit 202 determines whether or not there is any operation command for which a predetermined time period has elapsed after the transmission of the operation command). In a case where an electronic device to which an operation command is sent is in stop state, for example it is not started up, or continues to be in a busy status, there is the possibility that the electronic device can not immediately execute the received operation command or immediately provide notification of its status after executing the operation command. The server control unit 202 waits for the reception of a new status notification for a predetermined period of time. When there is an electronic device in which a predetermined time period has elapsed, the server control unit 202 proceeds the process to step S1303. When there is no electronic device in which a predetermined time period has elapsed, the server control unit 202 ends the present control.

In the step S1303, the server control unit 202 updates a simultaneous operation result indicating the statuses after the execution of operation commands, of the electronic devices related to the simultaneous operations. The simultaneous operation result may be registered and stored in the server storage unit 201 such that it can be obtained by the server notification management unit 203. In a case where the process in the step S1303 is carried out after the step S1302, the server control unit 202 registers the status after the execution of the operation command, of the electronic device, in which the predetermined time period has elapsed, as “No response” in the simultaneous operation result. In step S1304, after generating the simultaneous operation result, the server control unit 202 ends the notification management for the simultaneous operation command. After that, the server control unit 202 ends the present control.

When the notification management for the simultaneous operation command by the server control unit 202 has ended, the server notification management unit 203 loads information on the simultaneous operation result from the server storage unit 204 and sends it to the terminal apparatus 102 through the server communication unit 204. It is noted that the server notification management unit 203 can send information on the simultaneous operation result to the terminal group 103 in the communication system 100 as well. The server apparatus 104 may send the information on the simultaneous operation result to only a specific terminal apparatus 102 in the terminal group 103, which is set as a notification destination in advance. Thus, by sending the information on the simultaneous operation result to the terminal apparatus 102 in the terminal group 103, which is different from the terminal apparatus 102 with which the simultaneous operations were performed, it is possible to make an administrator of the electronic device or the like recognize the status of the electronic device. The administrator of the electronic device can recognize that an error has occurred in the electronic device under management. In this case, the information on the simultaneous operation result sent to the specific terminal apparatus 102 in the terminal group 103 may additionally include, for example, information on a user who performed the simultaneous operations. This enables the administrator of the electronic device to make contact with the user who performed the simultaneous operations after, for example, restoring the electronic device.

The step S1305 is executed in the case where the server communication unit 204 has received a new status notification. The server control unit 202 determines whether or not the new status notification received from the server communication unit 204 is a status notification from an electronic device included in the plurality of electronic devices being subjected to the simultaneous operations under the notification management. When determining that it is a status notification from an electronic device included in the electronic devices being subjected to the simultaneous operations under the notification management, the server control unit 202 proceeds the process to step S1306. When determining that it is a status notification from an electronic device which is not included in the electronic devices being subjected to the simultaneous operations under the notification management, the server control unit 202 proceeds the process to step S1308. In the step S1306, the server control unit 202 links a status indicated by the status notification and information on the electronic device with the simultaneous operations under the notification management, and stores them in the server storage unit 201.

In step S1307, the server control unit 202 determines whether or not status notifications have been obtained from all of the electronic devices related to the simultaneous operations. On this occasion, based on one or more status notifications stored in the server storage unit 201, the server control unit 202 can determine whether or not status notifications have been obtained from all of the electronic devices related to the simultaneous operations. When determining that status notifications have not been obtained from all of the electronic devices related to the simultaneous operations, the server control unit 202 ends the present control. When determining that status notifications have been obtained from all of the electronic devices related to the simultaneous operations, the server control unit 202 proceeds the process to step S1303. In the step S1303, the server control unit 202 registers statuses indicated by the statuses notifications as the statuses after the execution of the operation command, of the electronic devices, from which the status notifications have been obtained.

After that, in the step S1304, the server control unit 202 ends the notification management for the simultaneous operation command and ends the present control. When the notification management for the simultaneous operation command by the server control unit 202 has ended, the server notification management unit 203 loads information on a simultaneous operation result from the server storage unit 201 and sends it to the terminal apparatus 102 through the server communication unit 204. It is noted that the server notification management unit 203 can send the information on the simultaneous operation result to the terminal group 103 in the communication system 100 as well. Alternatively, the server apparatus 104 can send the information on the simultaneous operation result to only a specific terminal apparatus 102 in the terminal group 103, which is set as a notification destination in advance.

In the step S1308, the server control unit 202 registers the status notification, while considering it is a status notification from the electronic device which is not linked to the simultaneous operations, in the server notification management unit 203. When the status notification from the server control unit 202 has been registered, the server notification management unit 203 sends said status notification to the terminal apparatus 102 through the server communication unit 204. It is noted that the server notification management unit 203 can send the status notification to the terminal group 103 in the communication system 100 as well. The server apparatus 104 can send the status notification to only a specific terminal apparatus 102 in the terminal group 103, which is set as a notification destination in advance.

Thus, the server control unit 202 of the server apparatus 104 manages notifications in response to the reception of a simultaneous operation command for the plurality of electronic devices related to simultaneous operations. Notifications about the statuses of the electronic devices related to the simultaneous operations are, when they are received, stored in the server storage unit 201, not individually sent to the terminal apparatus 102. Upon receiving status notifications from all of the electronic devices related to the simultaneous operations, the server control unit 202 brings together the received statuses of the electronic devices related to the simultaneous operations and sends them as one simultaneous operation result to the terminal apparatus 102.

The server apparatus 104 collectively notifies the terminal apparatus 102 of the results of a simultaneous operation command. That is, the respective notifications about the statuses of electronic devices corresponding to operation commands are not individually sent to the terminal apparatus 102. One notification is added to the timeline screens on the terminal apparatus 102, as shown in FIG. 9. Particularly on the third timeline screen 909 in FIG. 9, the individual information on the electronic devices that have not successfully executed the operation commands is included in the result of simultaneous operations 912 based on one notification. By checking the added one notification, the user can collectively check the results of the simultaneous operations.

As described above, in the present embodiment, the terminal apparatus 102 can send a simultaneous operation command for simultaneously operating a plurality of electronic devices. Thus, the user can simultaneously operate a plurality of electronic devices. Moreover, in the present embodiment, a simultaneous operation command sent by the terminal apparatus 102 is not individually sent directly to each of the plurality of electronic devices, but is sent to the plurality of electronic devices via the server apparatus 104. Moreover, the server apparatus 104, based on one simultaneous operation command, generates individual commands for respective electronic devices related to the simultaneous operation command and sends them individually to said respective electronic devices. As a result, even if the plurality of electronic devices do not have common communication specifications for receiving the simultaneous operation command, they can be simultaneously operated.

Furthermore, in the present embodiment, electronic devices related to a simultaneous operation command sends notifications of their status after executing respective operation commands, to the server apparatus 104, which received the simultaneous operation command, and the server apparatus 104 receives the status notifications. At this time, the server apparatus 104 does not send the notifications about the statuses after the execution of respective operation commands, of the plurality of electronic devices related to the simultaneous operation command, as it is to the terminal device 102, but generates and sends one notification about the statuses of the plurality of electronic devices related to the simultaneous operation command. As a result, on the terminal apparatus 102, the user can collectively check the statuses of the plurality of electronic devices that have been simultaneously operated. This can reduce the burden of operation and checking on the user even if the number of electronic devices is increased.

In the present embodiment, even if the number of electronic devices to be collectively operated by the terminal apparatus 102 is increased, the burden of operation and checking on the user of the terminal apparatus 102 can be reduced. When performing simultaneous operations on a plurality of electronic devices, the user can easily check the results of the operations.

A description will now be given of a second embodiment of the present invention. Features different from those of the above-descried first embodiment will be mainly described below.

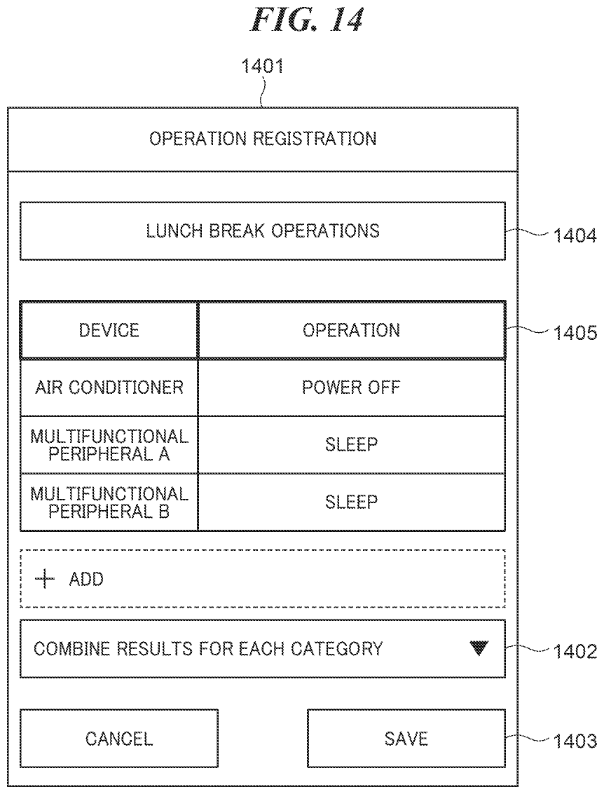

FIG. 14 is a view useful in explaining a variation of a screen displayed on the terminal apparatus 102 when simultaneous operations are registered in the server apparatus 104 in the communication system 100 according to the second embodiment of the present invention.

A pull-down button 1402 for selecting a communication method is allocated to an operation registration screen 1401 in FIG. 14, instead of the result combining setting 705 on the simultaneous operation registration screen 701 in FIG. 7. The pull-down button 1402 for selecting a communication method includes an item “Do not combine results”, an item “Combine all results”, and an item “Combine results for each category” such that they are selectable by user operation. Selection of the item “Do not combine results” is synonymous with setting the result combining setting 705 to OFF. Selection of the item “Combine all results” is synonymous with setting the result combining setting 705 to ON. Selection of the item “Combine results for each category” is synonymous with dividing electronic devices related to simultaneous operations into categories and combining results for each of the categories. The pull-down button 1402 in FIG. 14 is in a state where the user has selected the item “Combine results for each category”. When the user selects a save button 1403, a simultaneous operation name 1404, the details of an operation list 1405, and the item selected by the pull-down button 1402, at the time of the selection, are stored in the terminal storage unit 405. Also, the registration of the simultaneous operations is completed.

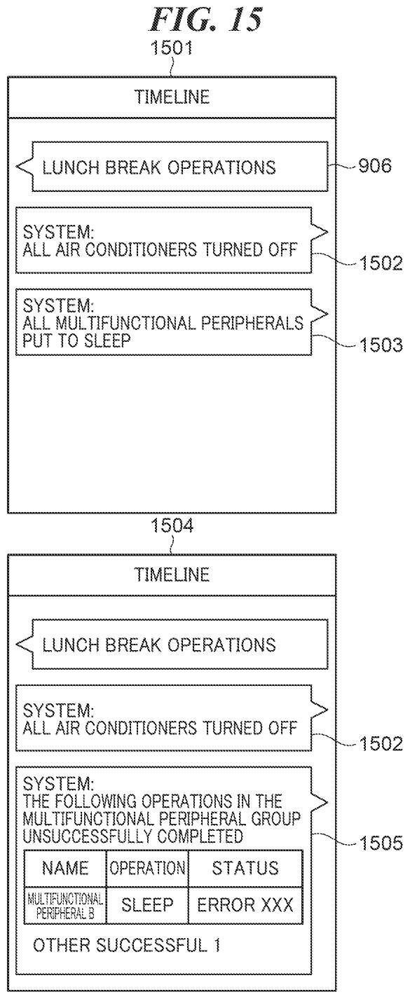

FIG. 15 is a view useful in explaining an example of a confirmation screen for the results of simultaneous operations, which is displayed on the terminal apparatus 102 in accordance with the execution of the simultaneous operations in the case where the simultaneous operations in FIG. 14 have been registered. FIG. shows a fourth timeline screen 1501 and a fifth timeline screen 1504 as a series of operating screens to be displayed on the terminal apparatus 102 for simultaneous operations such that they can be operated, as with FIG. 9.

The simultaneous operation name 906 of the simultaneous operations “Lunch break operations” selected on the simultaneous operation command execution screen 901 is displayed on the fourth timeline screen 1501, as with the second timeline screen 907 in FIG. 9. On the fourth timeline screen 1501, notifications about the statuses after the execution of operation commands, of electronic devices related to said simultaneous operations, are also displayed for category of electronic device. The terminal apparatus 102 collectively receives, from the server apparatus 104, status notifications, which are from the plurality of electronic devices belonging to the category of air conditioners and which indicate that all of the plurality of electronic devices have successfully executed operation commands. In this case, the terminal control unit 402 adds a simultaneous operation result 1502, which collectively indicates that all of the electronic devices belonging to the category of air conditioners have successfully executed operation commands, to the fourth timeline screen 1501. The terminal apparatus 102 also collectively receives, from the server apparatus 104, status notifications, which are from the plurality of electronic devices belonging to the category of multifunctional peripherals and which indicate that all of the plurality of electronic devices have successfully executed operation commands. In this case, the terminal control unit 402 adds a simultaneous operation result 1503, which collectively indicates that all of the electronic devices belonging to the category of multifunctional peripherals have successfully executed operation commands, to the fourth timeline screen 1501.

A description will now be given of a case where there are electronic devices which have not successfully executed operation commands. For example, the terminal apparatus 102 collectively receives, from the server apparatus 104, status notifications, which are from the plurality of electronic devices belonging to the category of multifunctional peripherals and which indicate that at least some of the plurality of electronic devices have not successfully executed operation commands. In this case, the terminal control unit 402 adds a simultaneous operation result 1505, which collectively indicates that some of the plurality of electronic devices belonging to the category of multifunctional peripherals have not successfully executed operation commands, to the fifth timeline screen 1504. The simultaneous operation result 1505 indicates that some of the plurality of electronic devices have successfully executed operation commands, and the rest of the plurality of electronic devices have not successfully executed operation commands.

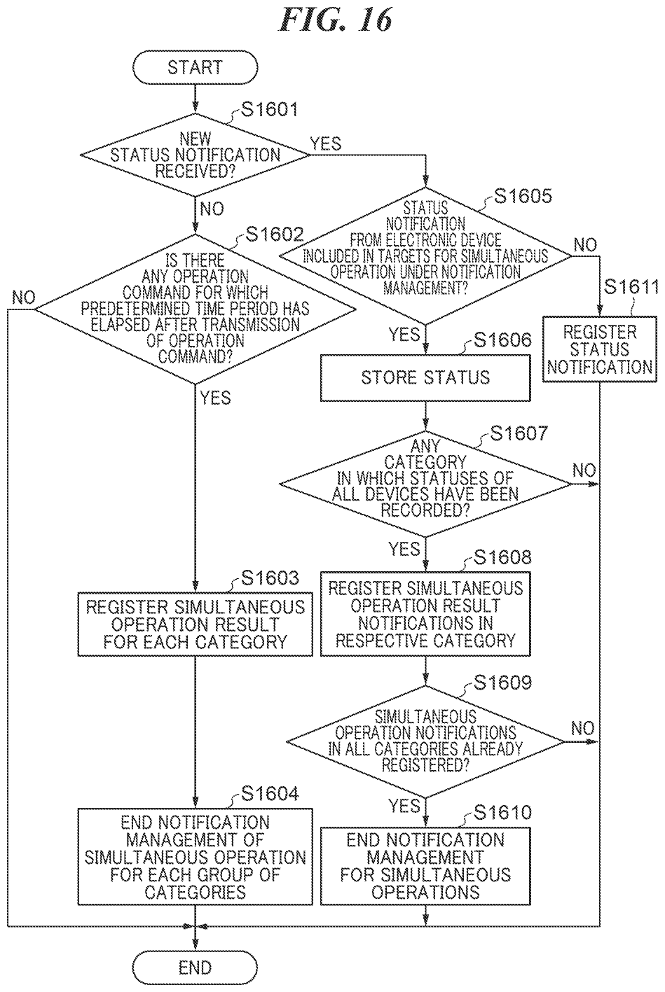

FIG. 16 is a flowchart showing how the server apparatus 104 controls the notifications of simultaneous operations, which is capable of displaying the confirmation screen in FIG. 15 on the terminal apparatus 102. The server control unit 202 of the server apparatus 104 that has already started notification management for a simultaneous operation command can repeatedly control the notification of simultaneous operations shown in FIG. 16 at regular time intervals while waiting for status notifications from the plurality of electronic devices related to the simultaneous operations.

Processes in step S1601 and step S1602 in FIG. 16 are the same as those in the step S1301 and step S1302 in FIG. 13. In S1603, for each group based on the categories of the electronic devices, the server control unit 202 updates (registers) simultaneous operation results indicating the statuses after the execution of operation commands, of the electronic devices related to the simultaneous operations. The simultaneous operation results in respective groups based on the categories of the electronic devices can be stored in the server storage unit 201 such that they can be obtained by the server notification management unit 203. The server control unit 202 registers the status after the execution of the operation command, of the electronic device, in which the predetermined time period has elapsed, as “No response” into the simultaneous operation result for each group based on the categories of the electronic devices. In step S1604, the server control unit 202 ends the notification management for the simultaneous operation command for each group based on the categories of the electronic devices, for which the simultaneous operation results have been created. After that, the server control unit 202 ends the present control.

When the server control unit 202 ends the notification management for the simultaneous operation command for a certain group, the server notification management unit 203 loads information on simultaneous operation results in the group, for which the notification management has ended, from the server storage unit 201. Then, the server notification management unit 203 sends the loaded information on the simultaneous operation results in the group, for which the notification management has ended, to the terminal apparatus 102 through the server communication unit 204. The server notification management unit 203 can send the information on the simultaneous operation results in the group, for which the notification management has ended, to the terminal group 103 in the communication system 100 as well. The server apparatus 104 can send the information on the simultaneous operation results in the group, for which the notification management has ended, to only a specific terminal apparatus 102 in the terminal group 103, which is set as a notification destination in advance.

Processes in step S1605, step S1606 and step S1611 in FIG. 16 are the same as those in the step S1305, the step S1306, and the step S1308 in FIG. 13. After the step S1606, the server control unit 202 proceeds the process to step S1607. In step S1607, the server control unit 202 determines whether or not there is a category in which all of the statuses of electronic devices belonging to this category have already been stored, among the categories of the electronic devices related to the simultaneous operations under the notification management. When determining that there is a category in which all of the statuses of electronic devices belonging to this category have already been stored, the server control unit 202 proceeds the process to step S1608. When determining that there is no category in which all of the statuses of electronic devices belonging to this category have already been stored, the server control unit 202 ends the present control. In the step S1608, the server control unit 202 updates the simultaneous operation results for the electronic devices belonging to the same category among the electronic devices related to the simultaneous operations. Simultaneous operation results in the respective groups based on the categories of the electronic devices can be registered and stored in the server storage unit 201 such that they can be obtained by the server communication management unit 203.

In step S1609, for all of the categories to which the electronic devices related to the simultaneous operations belong, the server control unit 202 determines whether or not execution result notifications have been registered in the server storage unit 201. When determining that execution result notifications about all of the categories have been registered, the server control unit 202 proceeds the process to step S1610. When determining that execution result notifications about all of the categories have not been registered, the server control unit 202 ends the present control. In the step S1610, the server control unit 202 ends the notification management for the simultaneous operation command, the result notifications to which have already been registered for all of the categories. After that, the server control unit 202 ends the present control.

When the notification management for the simultaneous operation command has ended, the server communication management unit 203 loads, from the server storage unit 201, information on simultaneous operation results about a group for which the notification management ended last and sends the information on the simultaneous operation results to the terminal apparatus 102 through the server communication unit 204. The server notification management unit 203 can send the information on the simultaneous operation results in the group, for which the notification management ended last, to the terminal group 103 in the communication system 100 as well. Alternatively, the server apparatus 104 can send the information on the simultaneous operation results in the group, for which the notification management ended last, to only a specific terminal apparatus 102 in the terminal group 103, which is set as a notification destination in advance.

Thus, the server apparatus 104 can group electronic devices related to a simultaneous operation command and send notifications about the respective groups to the terminal apparatus 102.

In the embodiment described above, the server control unit 202 of the server apparatus 104 receives, from the all of electronic devices related to simultaneous operations, the notifications of their statuses after the execution of operation commands, brings them together into one, and sends it to the terminal apparatus 102. However, the present invention is not limited to this. For example, the server control unit 202 can bring together only notifications about the statuses of electronic devices that have not successfully executed operation commands among the plurality of electronic devices related to simultaneous operations into one and send it to the terminal apparatus 102. The server control unit 202 can bring together only notifications about, for example, electronic devices for which notifications of execution errors have been provided into one and send it to the terminal apparatus 102.

In addition, for example, after sending operation commands related to simultaneous operations, the server control unit 202 can make an attempt to communicate with at least some of electronic devices related to the simultaneous operations. Then, based on whether or not there is a response to the attempt or whether or not a response indicating a desired status has been obtained, the server control unit 202 can determine whether on rot each electronic device is in a desired status. For example, in a case where although the server control unit 202 has sent an operation command to start an electronic device, there is no response from the electronic device or a notification indicating that the electronic device has not been started is sent from the electronic device, the server control unit 202 can assume (determine) that the electronic device is not in a desired status. As a result, for example, the terminal apparatus 102 and the server apparatus 104 can estimate (determine) the status of even an electronic device without the function of providing notification about its status after executing an operation command, based on the result of processing which the terminal apparatus 102 and the server apparatus 104 themselves have performed. Even electronic devices that are not configured to be compatible with the communication system according to the present embodiment can be included in electronic devices to be simultaneously operated.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-064067 filed on Apr. 7, 2022, which is hereby incorporated by reference wherein in its entirety.

What is claimed is:

1. A communication system comprising a terminal apparatus, a server apparatus, and a plurality of electronic devices configured to receive operation commands from the terminal apparatus via the server apparatus, wherein
the server apparatus comprises one or more controllers configured to function as:
a first unit configured to receive a simultaneous operation command for the plurality of electronic devices from the terminal apparatus;
a second unit configured to, based on the simultaneous operation command, send operation commands to respective electronic devices related to the simultaneous operation command;
a third unit configured to receive notifications of statuses after the execution of the operation commands from the respective electronic devices related to the simultaneous operation command; and
a fourth unit configured to send, to the terminal apparatus, one notification about the statuses of the respective electronic devices related to the simultaneous operation command.

2. The communication system according to claim 1, wherein the one or more controllers of the server apparatus function as the fourth unit to include, in the one notification to be sent to the terminal apparatus, individual statuses of at least electronic devices that have not successfully executed operation commands among the electronic devices related to the simultaneous operation command.

3. The communication system according to claim 1, wherein the one or more controllers of the server apparatus are further configured to function as:
a server storage unit configured to store information in which the simultaneous operation command received from the terminal apparatus and operation commands sent to the respective electronic devices related to the simultaneous operation command based on the simultaneous operation command are associated with each other; and
a server control unit configured to
obtain the simultaneous operation command received from the terminal apparatus by the first unit, and
based on the obtained the simultaneous operation command and the information stored in the server storage unit, send operation commands to the respective electronic devices related to the simultaneous operation command.

4. The communication system according to claim 3, wherein the server storage unit stores the information in which the simultaneous operation command received from the terminal apparatus and the operation commands to be sent to the respective the electronic devices are associated with each other.

5. The communication system according to claim 3, wherein the server control unit
after sending an operation command based on the simultaneous operation command to the respective electronic device related to the simultaneous operation command, makes an attempt to communicate with said respective electronic device, and
according to a result of the attempt, determines a status after the execution of the operation command, of the electronic device related to the simultaneous operation command.

6. The communication system according to claim 3, wherein the server control unit obtains a status of the electronic device related to the simultaneous operation command in advance, and in a case where the electronic device related to the simultaneous operation command is ready to execute an operation command, sends an operation command based on the simultaneous operation command to said electronic device.

7. The communication system according to claim 3, wherein in a case where after an operation command based on the simultaneous operation command is sent to the electronic device related to the simultaneous operation command, a status notification cannot be obtained from said electronic device related to the simultaneous operation command, the server control unit registers no response as a status after the execution of the operation command, of said electronic device related to the simultaneous operation command.

8. The communication system according to claim 3, wherein in a case where after an operation command based on the simultaneous operation command is sent to the electronic device related to the simultaneous operation command, a status notification indicating successful execution of the operation command cannot be obtained from the electronic device related to the simultaneous operation command, the server control unit sends again the operation command to the electronic device related to the simultaneous operation command.

9. The communication system according to claim 3, wherein the server control unit
after sending operation commands based on the simultaneous operation command, makes an attempt to communicate with at least some of the electronic devices related to the simultaneous operation command, and
based on whether or not a response to the attempt has been received or based on whether or not a response indicating a desired status has been obtained, determines whether or not the at least some of electronic devices is in a desired status.

10. The communication system according to claim 1, wherein the one or more controllers of the server apparatus function as the fourth unit to divide the plurality of electronic devices related to the simultaneous operation command into a plurality of groups and sends notifications for the respective groups to the terminal apparatus.

11. A server apparatus comprising:
a communication unit configured to communicate with a terminal apparatus and a plurality of electronic devices capable of executing a command from the terminal apparatus; and
a control unit configured to
receive, by the communication unit, a simultaneous operation command for the plurality of electronic devices from the terminal apparatus
based on the simultaneous operation command, send commands, to respective electronic devices related to the simultaneous operation command from the communication unit,
receive, by the communication unit, notifications of statuses after the execution of the commands, from the respective electronic devices related to the simultaneous operation command, and
send one notification about the statuses of the electronic devices related to the simultaneous operation command to the terminal apparatus from the communication unit.

12. A control method for a server apparatus that has a communication unit configured to communicate with a terminal apparatus and a plurality of electronic devices capable of executing a command from the terminal apparatus, and a control unit,
the control method comprising:
receiving, by the communication unit, a simultaneous operation command for the plurality of electronic devices from the terminal apparatus;
based on the simultaneous operation command, sending commands, to respective electronic devices related to the simultaneous operation command from the communication unit;
receiving, by the communication unit, notifications of statuses after the execution of the commands, from the respective electronic devices related to the simultaneous operation command; and
sending one notification about the statuses of the electronic devices related to the simultaneous operation command to the terminal apparatus from the communication unit.

13. A non-transitory storage medium storing a computer-executable program for executing a control method for a server apparatus that has a communication unit configured to communicate with a terminal apparatus and a plurality of electronic devices capable of executing a command from the terminal apparatus, and a control unit,
the control method comprising:
receiving, by the communication unit, a simultaneous operation command for the plurality of electronic devices from the terminal apparatus;
based on the simultaneous operation command, sending commands, to respective electronic devices related to the simultaneous operation command from the communication unit;
receiving, by the communication unit, notifications of statuses after the execution of the commands, from the respective electronic devices related to the simultaneous operation command; and
sending one notification about the statuses of the electronic devices related to the simultaneous operation command to the terminal apparatus from the communication unit.

14. The non-transitory storage medium according to claim 13, wherein the method includes including, in the one notification to be sent to the terminal apparatus, individual statuses of at least electronic devices that have not successfully executed operation commands among the electronic devices related to the simultaneous operation command.

15. The non-transitory storage medium according to claim 13, wherein the method further includes:
storing, in a server storage unit, information in which the simultaneous operation command received from the terminal apparatus and operation commands sent to the respective electronic devices related to the simultaneous operation command based on the simultaneous operation command are associated with each other; and
obtaining the simultaneous operation command received from the terminal apparatus, and
based on the obtained the simultaneous operation command and the information stored in the server storage unit, sending operation commands to the respective electronic devices related to the simultaneous operation command.

16. The non-transitory storage medium according to claim 15, wherein the server storage unit stores the information in which the simultaneous operation command received from the terminal apparatus and the operation commands to be sent to the respective the electronic devices are associated with each other.

17. The non-transitory storage medium according to claim 15, wherein the method includes:
after sending an operation command based on the simultaneous operation command to the respective electronic device related to the simultaneous operation command, making an attempt to communicate with said respective electronic device; and
according to a result of the attempt, determining a status after the execution of the operation command, of the electronic device related to the simultaneous operation command.

18. The non-transitory storage medium according to claim 15, wherein the method includes:
obtaining a status of the electronic device related to the simultaneous operation command in advance; and
in a case where the electronic device related to the simultaneous operation command is ready to execute an operation command, sending an operation command based on the simultaneous operation command to said electronic device.

19. The non-transitory storage medium according to claim 15, wherein the method includes
in a case where after an operation command based on the simultaneous operation command is sent to the electronic device related to the simultaneous operation command, a status notification cannot be obtained from said electronic device related to the simultaneous operation command, registering no response as a status after the execution of the operation command, of said electronic device related to the simultaneous operation command.

20. The non-transitory storage medium according to claim 15, wherein the method includes
in a case where after an operation command based on the simultaneous operation command is sent to the electronic device related to the simultaneous operation command, a status notification indicating successful execution of the operation command cannot be obtained from the electronic device related to the simultaneous operation command, sending again the operation command to the electronic device related to the simultaneous operation command.
